(19) United States
(12) Patent Application Publication
(10) Pub. No.: US 2005/0109342 A1
(43) Pub. Date: May 26, 2005

(54) Mask with elastic headband

(75) Inventor: John R. Easom, Garfield, NJ (US)

Correspondence Address: R. GALE RHODES, JR., OF COUNSEL;MOSER, PATTERSON & SHERIDAN, L.L.P., Suite 100, 595 Shrewsbury Avenue, Shrewsbury, NJ, 07702, US

(73) Assignee: Vital Signs Inc.

(21) Appl. No.: 10/718,469

(22) Filed: Nov. 20, 2003

(51) Int. Cl. A62B 7/10

(52) U.S. Cl. 128/206.12

(57) ABSTRACT

A mask including a shell provided with a perimeter and provided with a generally opposed and outwardly extending gas inlet conduit; a seal mounted to the perimeter; and a one-piece elastic headband provided with an opening through which the conduit extends to mount the headband and shell together.

### BACKGROUND OF THE INVENTION

This invention relates to a mask and more particularly relates to a nasal mask.

Numerous masks are known to the art for conveying breathable gas such as oxygen, oxygen enriched air, anesthesia gas, to a person. Full face masks are known for covering both the nose and mouth of a person and for sealingly engaging portions of the person's face surrounding the nose and mouth. Nasal masks are known to the art for covering only the nose of a person and for sealingly engaging portions of the person's face surrounding the nose. Such masks are typically mounted to a person's face and head by head gear comprising a plurality of straps which fasten around the sides of and over the top of the person's head. It is well known that such head gear is typically uncomfortable to wear and is at last somewhat burdensome to attach and remove from the person's head. Further, when masks employing such head gear are utilized in a sleep apnea system, the person undergoing sleep apnea treatment typically has to get up in the middle of the night for various reasons and before doing so must either disconnect the mask from the sleep apnea equipment or unfasten the mask by loosening and removing the plurality of straps. When returning to bed and resuming the sleep apnea treatment, the person must reattach the mask by refastening the plurality of straps. This removal and re-attachment of the mask is both cumbersome and bothersome and can tend to make the person more awake than is desirable during the sleep apnea treatment.

Accordingly, there is a need in the art for a new and improved mask provided with head gear which is relatively inexpensive, more comfortable for wearing and more easily attached to and removed from the person's face and head.

### SUMMARY OF THE INVENTION

A mask including a shell provided with a perimeter and provided with a generally opposed and outwardly extending gas inlet conduit; a seal mounted to the perimeter; and a one-piece elastic headband provided with an opening through which the conduit extends to mount the headband and shell together.

### DESCRIPTION OF THE DRAWINGS

FIG. 1 is a top left side perspective view of a nasal mask provided with an elastic headband and embodying the present invention;

FIG. 2 is a front top perspective view of the mask of FIG. 1;

FIG. 3 is a cross-sectional view taken generally along the line 3-3 in FIG. 2 in the direction of the arrows;

FIG. 4 is an exploded view of the nasal mask of FIG. 1;

FIG. 5 is a side view of a nasal mask embodying the present invention shown mounted to the face and head of a person; and

FIG. 6 is a side view of an alternate embodiment of the mask of the present invention shown mounted to the face and head of a person.

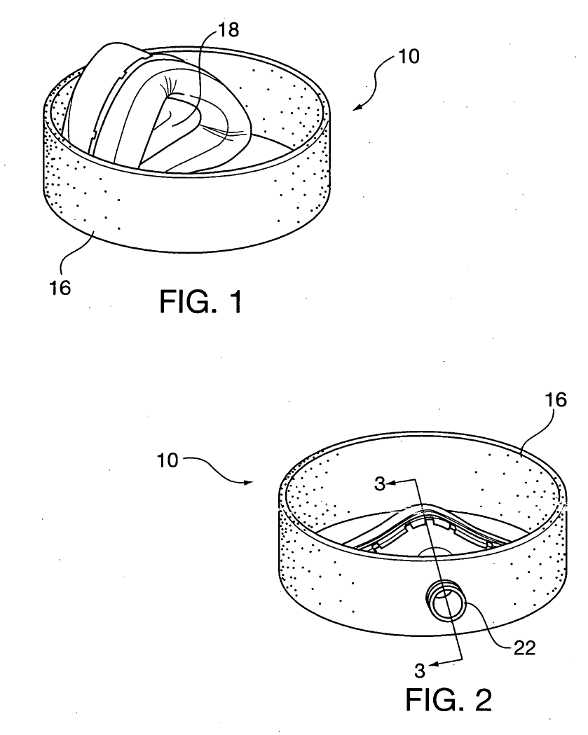

### DESCRIPTION OF THE PREFERRED EMBODIMENT

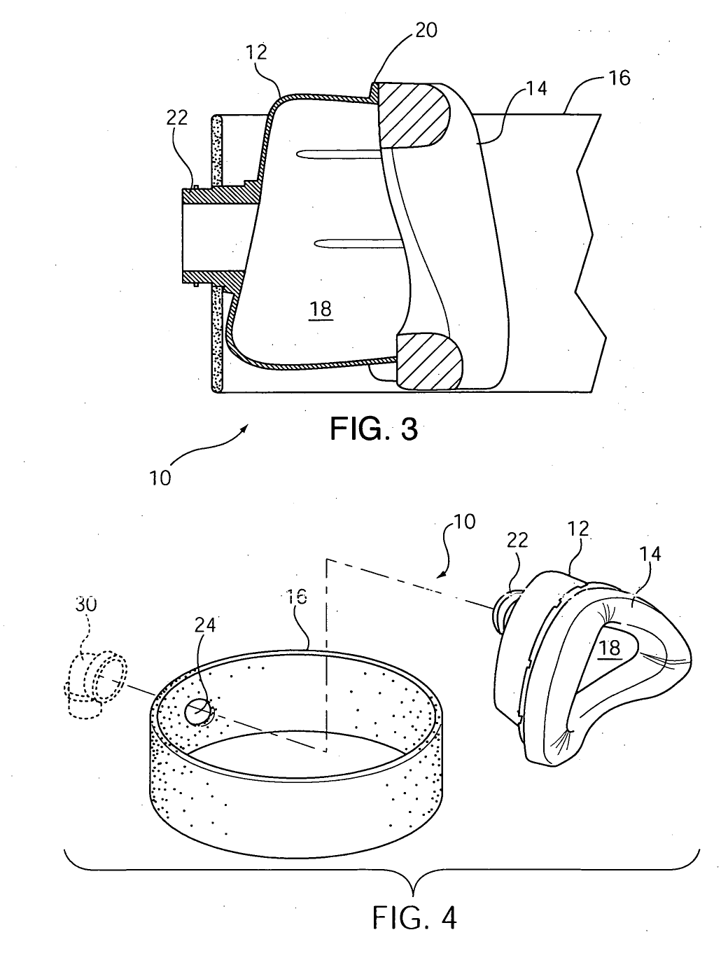

A nasal mask embodying the present invention is shown in the drawings and indicated by general numerical designation 10. The nasal mask 10 includes a generally triangular hollow shell 12, note particularly FIGS. 3 and 4, a seal 14 and a one-piece elastic headband which in the preferred embodiment is an annular elastic headband 16.

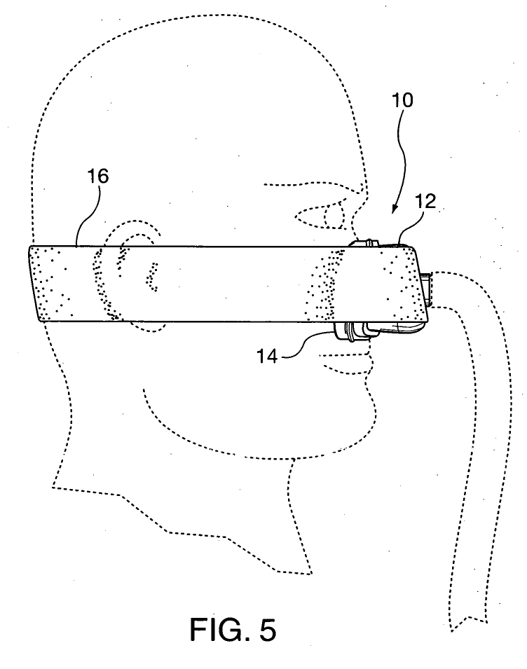

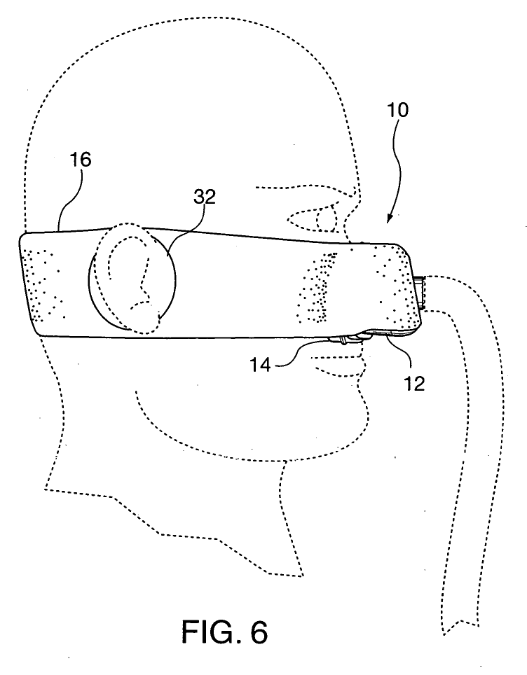

The shell 12, as may be noted particularly from FIGS. 3 and 4, is a generally triangular hollow shell providing a chamber 18 for receiving breathable gas to be supplied to the nose of the person indicated diagrammatically in side view in FIG. 5. The shell 12, again note particularly FIG. 3, includes an outer generally triangular perimeter 20 to which the seal 14 is mounted. The shell 12 is provided with an outwardly extending gas inlet conduit 22 which is disposed generally opposite the shell perimeter 20. The headband 16, note particularly FIG. 4, is provided with an opening 24 through which the gas inlet conduit 22 extends to mount the headband 16 to the shell 12.

As will be understood from FIG. 4, after the gas inlet conduit 22 is extended through the headband opening 24, the gas inlet conduit 22 may be connected to a suitable elbow connector 30 which in turn may be connected to a suitable tube, such as a corrugated tubing not shown, through which breathable gas is supplied through the elbow connector 30, through the gas inlet conduit 22, into the chamber 18 and thereby to the nose of the person as indicated diagrammatically in FIG. 5.

The shell 12 may be a flexible shell made of a suitable flexible plastic material and made by suitable molding means. The seal 14 may be made of a suitable soft material of the type known to the art for being used as mask seals and may be suitably mounted or affixed to the shell perimeter 20 such as by suitable bonding. Such seal material is suitably soft so as to be able to conform to the contours of the person's face surrounding the person's nose, as shown in FIG. 5, to permit the seal 14 and thereby the nasal mask 10 to sealingly engage the portions of the person's face surrounding the nose. The elastic headband 16 may be made of suitable commercially available elastic material and made into an annulus by suitable manufacturing means such as, for example, by cutting and stitching. Such material may be, for example, elastic material typically used as a sweatband worn for sports.

In use, the headband 16 is stretched radially outwardly to surround the person's head and then released to mount the nasal mask to the person's face and head as shown in FIG. 5; for removal, the headband 16 is again stretched radially outwardly and pulled upwardly over the person's head or may be merely pulled upwardly over the person's head.

As shown in FIG. 6, in an alternate embodiment, the annular elastic headband 16 may be provided with a pair of generally opposed ear holes 32, only one ear hole being shown in FIG. 4, through which a person's ears may extend to assist in mounting the nasal mask to the person's face and head as shown in FIG. 6, and to further assure stability and provide added comfort.

In the preferred embodiment, the headband 16 was approximately 1½-2″ in width. Alternatively, the portion of the elastic headband residing across the mask could be made wider than the remaining portion of the headband or shaped as a cup, or sock to encompass the entire mask.

It will be understood that the mask of the present invention may be embodied other than as a nasal mask and may be embodied, such as for example, as a full face mask.

It will be further understood by those skilled in the art that many variations and modifications may be made in the present invention without departing from the spirit and the scope thereof.

1. A mask, comprising:
a shell provided with a perimeter and including an outwardly extending gas inlet conduit disposed generally opposite said perimeter;
a seal mounted to said perimeter; and
a one-piece elastic headband provided with an opening through which said conduit extends to mount said headband to said shell.

2. The mask according to claim 1 wherein said one-piece elastic headband is an annular elastic headband.

3. The mask according to claim 2 wherein said headband is provided with a pair of generally opposed ear holes.

4. A nasal mask, comprising:
a generally triangular hollow shell providing an internal gas chamber and including an outer generally triangular perimeter, said shell provided with an outwardly extending gas inlet conduit generally opposed to said perimeter;
a seal mounted to said perimeter and for sealingly engaging portions of a person's face surrounding the person's nose; and
an annular elastic headband provided with an opening through which said conduit extends to mount said headband to said shell, said headband for being stretched generally radially outwardly to surround the person's head and to removably mount said nasal mask to said person for the receipt of breathable gas.

5. The nasal mask according to claim 4 wherein said head band is provided with a pair of generally opposed ear holes for permitting the person's ears to extend therethrough to assist in mounting said nasal mask to the person's head.

6. The nasal mask according to claim 4 wherein said headband is approximately 1½-2″ wide.
